(19) United States
(12) Patent Application Publication
(10) Pub. No.: US 2003/0090434 A1
(43) Pub. Date: May 15, 2003

(54) Method for arranging receiving antenna of communication apparatus

(75) Inventor: Hideki Masudaya, Miyagi-ken (JP)

Correspondence Address: Brinks Hofer Gilson & Lione, P.O. Box 10395, Chicago, IL, 60611, US

(73) Assignee: Alps Electric Co., Ltd.

(21) Appl. No.: 10/293,029

(22) Filed: Nov. 13, 2002

(30) Foreign Application Priority Data
Nov. 15, 2001 (JP) 2001-350429

(51) Int. Cl. H01Q 21/00; H01Q 11/12

(52) U.S. Cl. 343/867; 340/5.61; 343/742

(57) ABSTRACT

A receiving antenna for receiving low frequency signals is constituted by arranging two loop antenna elements and one air-core loop antenna element close to each other, wherein the two loop antenna elements are arranged in combination such that a magnetic flux which passes an axis of each one loop antenna element is prevented from passing an axis of another loop antenna element, and one air-core loop antenna element is arranged in combination with the two loop antenna elements such that an axis of the air-core loop antenna crosses respective axes of the one and other loop antenna elements orthogonally.

### BACKGROUND OF THE INVENTION

1. Field of the Invention

The present invention relates to a method for arranging a receiving antenna, and more particularly to a method for arranging a receiving antenna which adopts an arrangement of combination in which, when two loop antenna elements and one air-core loop antenna element or three loop antenna elements are arranged in combination, a magnetic flux which passes an axis of each antenna element does not pass axes of other antenna elements whereby favorable resonance characteristics can be obtained with respect to respective antenna elements.

2. Description of the Related Art

Conventionally, a passive remote keyless entry device used in an automobile is constituted of a vehicle-mounted transmitting/receiving apparatus mounted on the automobile and one or more portable transmitting/receiving apparatus which an owner of the automobile or the like carries with him. In use, the transmission and reception of radio signals are performed between the vehicle-mounted transmitting/receiving apparatus and one or more portable transmitting/receiving apparatus. In this type of passive mode keyless entry device, when the radio signals are transmitted from one or more portable transmitting/receiving apparatus to the vehicle-mounted transmitting/receiving apparatus, high-frequency radio signals are used such that the radio signals can cover a relatively long distance even with the low power transmission. On the other hand, when the radio signals are transmitted from the vehicle-mounted transmitting/receiving apparatus to the portable transmitting/receiving apparatus, to minimize the influence of the radio signals transmitted from the vehicle-mounted transmitting/receiving apparatus to other equipment, usually low-frequency radio signals of a frequency band in a range from 100 to 150 KHz are adopted such that the reachable distance of the radio signals is restricted, and a low-frequency receiving antenna which receives the low-frequency radio signals is provided at the portable transmitting/receiving apparatus side. In many cases, such a low-frequency receiving antenna adopts, to ensure the reception of the low-frequency radio signals, a structure in which two or more small-sized loop antenna elements constituted of single-core coil shaped antenna element shaving ferrite material as a core are combined. With respect to the received signals obtained by these loop antenna elements, since the received signals from the loop antenna element which receives the radio signals having the maximum electric field intensity are selectively sampled, it is possible to receive the low-frequency radio signals with relatively high sensitivity.

Here, FIG. 7 is a circuit constitutional diagram which shows one example of the constitution of an essential part of a known receiving antenna which is formed by combining two loop antenna elements, wherein a part of the constitution is shown as a block.

As shown in FIG. 7, the known receiving antenna includes a first loop antenna element 71 and a second loop antenna element 72 which are made of single-core coil-shaped antenna elements having cores made of ferrite material, a first resonance capacitor 73 which is connected in parallel with the first loop antenna element 71, a second resonance capacitor 74 which is connected in parallel with the second loop antenna element 72, a first differential amplifier 75, a second differential amplifier 76, a first level detector 77, a second level detector 78, a signal selector 79, and a signal output terminal 80. In this case, a first parallel resonance circuit 81 is constituted of the first loop antenna element 71 and the first resonance capacitor 73, a second parallel resonance circuit 82 is constituted of the second loop antenna element 72 and the second resonance capacitor 74, and a signal receiver 83 is constituted of the first differential amplifier 75, the second differential amplifier 76, the first level detector 77, the second level detector 78, the signal selector 79 andthe signal output terminal 80.

Then, the first differential amplifier 75 has a first input end thereof connected to one end of the first parallel resonance circuit 81, a second input end thereof connected to another end of the first parallel resonance circuit 81, and an output end thereof connected to an input end of the first level detector 77 and a first input end of the signal selector 79. The second differential amplifier 76 has a first input end thereof connected to one end of the second parallel resonance circuit 82, a second input end thereof connected to another end of the second parallel resonance circuit 82, and an output end thereof connected to an input end of the second level detector 78 and a second input end of the signal selector 79. The first level detector 77 has an output end thereof connected to a first control end of the signal selector 79 and the second level detector 78 has an output end thereof connected to a second control end of the signal selector 79. The signal selector 79 has an output end thereof connected to the signal output terminal 80.

The receiving antenna having the above-mentioned constitution is operated as follows.

Here, when the low-frequency radio signals are transmitted from the vehicle-mounted transmitting/receiving apparatus (not shown in FIG. 7) and the transmitted low-frequency radio signals arrive at the low-frequency receiving antenna of the portable transmitting/receiving apparatus, the first loop antenna element 71 and/or the second loop antenna element 72 detect the low-frequency radio signals. Here, since the first parallel resonance circuit 81 including the first loop antenna element 71 and/or the second parallel resonance circuit 82 including the second loop antenna element 72 are constituted such that they are subjected to the parallel resonance to the frequency of the low-frequency radio signals, the received signals having frequencies of respective low-frequency radio signals are formed in the first parallel resonance circuit 81 and/or the second parallel resonance circuit 82. The received signals formed in the first parallel resonance circuit 81 are subjected to the differential amplification by the first differential amplifier 75 and are converted into the first received signals, and the first received signals are supplied to the first level detector 77 and the signal selector 79. In the same manner, the received signals formed in the second parallel resonance circuit 82 are subjected to the differential amplification by the second differential amplifier 76 and are converted into the second received signals, and the second received signals are supplied to the second level detector 78 and the signal selector 79.

The first level detector 77 detects a level of the first received signals supplied from the first differential amplifier 75 and supplies a first detection output corresponding to the first received signal level to the signal selector 79. The second level detector 78 detects a level of the second received signals supplied from the second differential amplifier 76 and supplies a second detection output corresponding to the second received signal level to the signal selector 79. The signal selector 79 compares magnitudes of the supplied first detection output and second detection output. When the signal selector 79 determines that the first detection output is larger as a result of such a comparison, the signal selector 79 selectively outputs the first received signal supplied from the first differential amplifier 75 and supplies the first received signal to the signal output terminal 80. On the other hand, when the signal selector 79 determines that the second detection output is larger as a result of such a comparison, the signal selector 79 selectively outputs the second received signal supplied from the second differential amplifier 76 and supplies the second received signal to the signal output terminal 80. One of the first received signal and the second received signal supplied to the signal output terminal 80 is supplied to a received signal processor (not shown in FIG. 7) which follows the signal receiver 83.

In general, with respect to the portable transmitting/receiving apparatus, because of its portability, it is necessary to make constitutional parts small-sized and light-weighted. It is also necessary to arrange these constitutional parts such that they are disposed close to each other. In this respect, a known low-frequency receiving antenna which is used in the portable transmitting/receiving apparatus is not an exception. Accordingly, in constituting the low-frequency receiving antenna, the first and second loop antenna elements 61, 62 are also miniaturized and arranged such that they are disposed close to each other.

With respect to the known low-frequency receiving antenna, it has been known that to enhance the reception sensitivity of the low-frequency receiving antenna, it is preferable to adopt the combination of three coil-shaped antenna elements. In this case, when a third antenna element is provided in addition to the first and second loop antenna elements 71, 72, besides the mutual interference of magnetic fluxes between the first and second loop antenna elements 71, 72, the mutual interference of magnetic fluxes between the first or the second loop antenna element 71, 72 and the third antenna element is added so that not only the selection characteristics in the first parallel resonance circuit 81 and the second parallel resonance circuit 82 is deteriorated, but also the selective characteristics of the parallel resonance circuit including the third antenna element is deteriorated. Accordingly, even when the third antenna element is provided, it is difficult to expect the desired enhancement of the reception sensitivity.

Further, with respect to the known low-frequency receiving antenna, to enable the first and the second loop antenna elements 71, 72 to receive the low-frequency radio signals efficiently, as shown in FIG. 7, the first and the second loop antenna elements 71, 72 are arranged close to each other and their axes are arranged close to each other orthogonally. By adopting such an arrangement, provided that one end of the first loop antenna element 71 and one end of the second loop antenna element 72 are spaced apart from each other with a distance of a fixed value or more, the mutual interference of magnetic fluxes is hardly generated between the first and the second loop antenna elements 71, 72 and hence, there arises no problem. However, when one end of the first loop antenna element 71 and one end of the second loop antenna element 72 are arranged such that these ends are disposed close to each other to achieve the miniaturization of the low-frequency receiving antenna, a part or the whole of the magnetic flux which passes the axis of the first loop antenna element 71 passes the axis of the second loop antenna element 72. Further, apart or the whole of the magnetic flux which passes the axis of the second loop antenna element 72 passes the axis of the first loop antenna element 71. Accordingly, there arises the mutual interference of magnetic fluxes between the first loop antenna element 71 and the second loop antenna element 72.

When the mutual interference of magnetic fluxes is generated between the first and the second loop antenna elements 71, 72, the selective characteristics of the first parallel resonance circuit 81 and/or the second parallel resonance circuit 82 is deteriorated compared to the prescribed selective characteristics, and the signal levels which are formed in the first parallel resonance circuit 81 and/or the second parallel resonance circuit 82 are decreased to make it difficult to maintain the first parallel resonance circuit 81 and the second parallel resonance circuit 82 in a favorable state whereby the reception sensitivity of the low-frequency antenna is reduced.

### SUMMARY OF THE INVENTION

The present invention has been made in view of such a technical background and it is an object of the present invention to provide a method for arranging receiving antennas in which, when three antenna elements are arranged close to each other, the arrangement which does not generate mutual interference of magnetic fluxes among them is adopted so that resonance characteristics of three parallel resonance circuits are maintained in a favorable state whereby reception sensitivity with respect to low-frequency radio signals can be enhanced.

To achieve the above-mentioned object, a method for arranging a receiving antenna according to the present invention includes first means in which the receiving antenna is constituted by arranging two loop antenna elements and one air-core loop antenna element close to each other, wherein the two loop antenna elements are arranged in combination such that a magnetic flux which passes an axis of each one loop antenna element is prevented from passing an axis of another loop antenna element, and the one air-core loop antenna element is arranged in combination with the two loop antenna elements such that an axis of the air-core loop antenna element crosses respective axes of the one and other loop antenna elements orthogonally.

According to the first means, with respect to two loop antenna elements, they are arranged in combination such that a magnetic flux which passes an axis of each one loop antenna element is prevented from passing an axis of another loop antenna element. On the other hand, with respect to one air-core loop antenna element, such a loop antenna element is arranged in combination with two loop antenna elements such that a magnetic flux which passes an axis of the air-core loop antenna passes neither the axis of one loop antenna element nor the axis of another loop antenna element. Accordingly, the generation of the mutual interference of magnetic fluxes between one and another loop antenna elements and the generation of the mutual interference of magnetic fluxes betweenone air-core loop antenna element and the one and other loop antenna elements can be eliminated. Accordingly, it is possible to maintain in a favorable state the resonance characteristics of a first parallel resonance circuit which is constituted of one loop antenna element and a resonance capacitor which is connected to one loop antenna element in parallel, the resonance characteristics of a second parallel resonance circuit which is constituted of another loop antenna element and a resonance capacitor which is connected to another loop antenna element in parallel, and the resonance characteristics of a third parallel resonance circuit which is constituted of the air-core loop antenna element and a resonance capacitor which is connected to the air-core loop antenna element in parallel. Accordingly, even when two loop antenna elements and one air-core loop antenna element are arranged close to each other to miniaturize the receiving antenna, the reception sensitivity can be enhanced without lowering the reception sensitivity with respect to low-frequency radio signals.

In this case, it is preferable that two loop antenna elements in the above-mentioned first(means are arranged in combination such that these loop antenna elements cross each other approximately orthogonally in a state that one end of the one loop antenna element faces a side face of the other loop antenna element.

Due to such a constitution, it is possible to surely suppress the generation of the mutual interference of the magnetic fluxes between one and another loop antenna elements. Accordingly, even when one and another loop antenna elements are arranged close to each other and air-core loop antenna element is arranged close to one and another loop antenna elements, there arises no lowering of the reception sensitivity with respect to the low-frequency radio signals so that the reception sensitivity can be enhanced.

Further, it is preferable that two loop antenna elements in the above-mentioned first means are arranged in combination such that these loop antenna elements cross each other substantially orthogonally in a state that one loop antenna element and another loop antenna element overlap each other.

Due to such a constitution, it is possible to surely suppress the generation of the mutual interference of the magnetic fluxes between one and another loop antenna elements. Further, it is possible to confine an arrangement region of loop antenna elements when one and another loop antenna elements are arranged close to each other to a minimum range so that the optimum miniaturization can be realized. Still further, even when the air-core loop antenna element is arranged close to one and another loop antenna elements, there arises no lowering of the reception sensitivity with respect to the low-frequency radio signals so that the reception sensitivity can be enhanced.

Further, to achieve the above-mentioned object, a method for arranging a receiving antenna according to the present invention includes second means in which the receiving antenna is constituted by arranging three loop antenna elements close to each other, wherein the three loop antenna elements are arranged in combination such that an axis of each one loop antenna element crosses respective axes of other two loop antenna elements orthogonally, and a magnetic flux which passes each one loop antenna element is prevented from passing respective axes of the other two loop antenna elements.

According to the above-mentioned second means, with respect to respective three loop antenna elements, these loop antenna elements are arranged in combination such that the axis of one loop antenna element crosses respective axes of other two loop antenna elements. Further, these loop antenna elements are arranged in combination such that the magnetic flux which passes the axis of one loop antenna element is prevented from passing the axes of other two loop antenna elements. Accordingly, it is possible to eliminate the generation of the mutual interference of magnetic fluxes between respective two of three loop antenna elements so that it is possible to maintain the resonance characteristics of respective parallel resonance circuits each of which is constituted of each loop antenna element and the resonance capacitor which is connected to the loop antenna element in parallel in a favorable state. Accordingly, even when three loop antenna elements are arranged close to each other for miniaturizing the receiving antenna, it is possible to prevent the lowering of the reception sensitivity with respect to the low-frequency radio signals so that the reception sensitivity can be enhanced.

### BRIEF EXPLANATION OF DRAWINGS

FIG. 1 is a circuit constitutional view showing the first embodiment of a method for arranging a receiving antenna according to the present invention, wherein the constitution of an essential part of the receiving antenna is shown with a part indicated by a block.

FIG. 2 is a constitutional view showing one example of the receiving antenna of the first embodiment, wherein two loop antenna elements and one air-core loop antenna element are mounted and are arranged on a printed circuit board.

FIG. 3 is acircuit constitutional view showing the second embodiment of a method for arranging a receiving antenna according to the present invention, wherein the constitution of an essential part of the receiving antenna is shown with a part indicated by a block.

FIG. 4 is a constitutional view showing one example of the receiving antenna of the second embodiment, wherein two loop antenna elements and one air-core loop antenna element are mounted and arranged on a printed circuit board.

FIG. 5 is a circuit constitutional view showing the third embodiment of a method for arranging a receiving antenna according to the present invention, wherein the constitution of an essential part of the receiving antenna is shown with a part indicated by a block.

FIG. 6 is a block diagram showing one embodiment of the constitution of an essential part of a portable transmitting/receiving apparatus provided with the receiving antenna of one of the first to third embodiments.

FIG. 7 is a circuit constitutional view showing one example of the constitution of an essential part of a known receiving antenna which is formed by combining two antenna elements with a part indicated as a block.

### DESCRIPTION OF PREFERRRED EMBODIMENTS

Preferred embodiments of the present invention are explained hereinafter in conjunction with attached drawings.

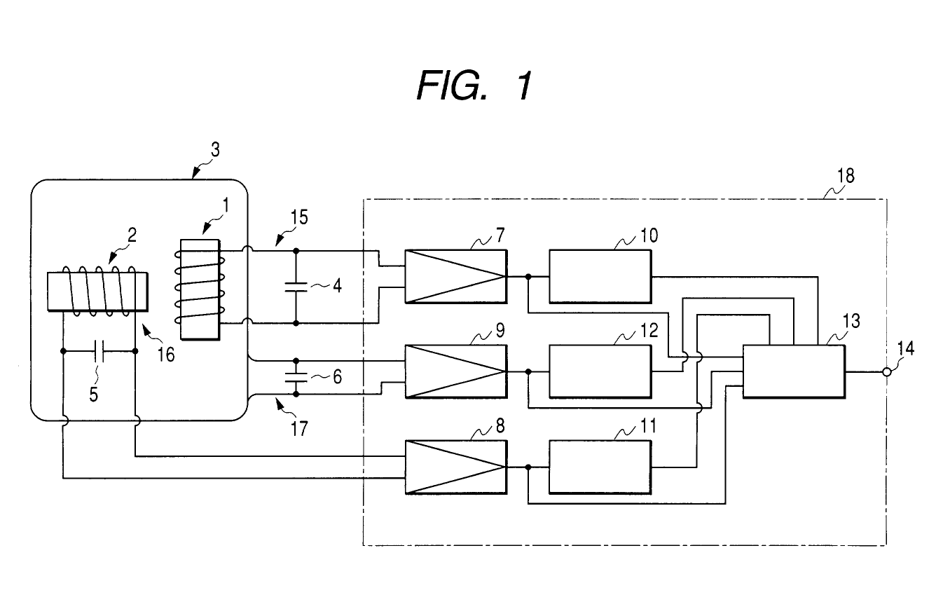

FIG. 1 is a circuit constitutional view showing the first embodiment of a method for arranging a receiving antenna according to the present invention, wherein the constitution of an essential part of the receiving antenna is shown with a part indicated by a block.

As shown in FIG. 1, a receiving antenna according to the first embodiment includes a first loop antenna element 1 and a second loop antenna element 2 which are constituted of single-core coil-shaped antenna elements having cores made of ferrite material, an air-core loop antenna element 3, a first resonance capacitor 4 which is connected in parallel with the first loop antenna element 1, a second resonance capacitor 5 which is connected in parallel with the second loop antenna element 2, a third resonance capacitor 6 which is connected in parallel with the air-core loop antenna element 3, a first differential amplifier 7, a second differential amplifier 8, a third differential amplifier 9, a first level detector 10, a second level detector 11, a third level detector 12, a signal selector 13, and a signal output terminal 14.

Here, a first parallel resonance circuit 15 is constituted of the first loop antenna element 1 and the first resonance capacitor 4, a second parallel resonance circuit 16 is constituted of the second loop antenna element 2 and the second resonance capacitor 5, and a third parallel resonance circuit 17 is constituted of the air-core loop antenna element 3 and the third resonance capacitor 6. Further, a signal receiver 18 is constituted of the first differential amplifier 7, the second differential amplifier 8, the third differential amplifier 9, the first level detector 10, the second level detector 11, the third level detector 12, the signal selector 13, and the signal output terminal 14.

In this case, the arrangement mode of the first loop antenna element 1 and the second loop antenna element 2 adopts the combination arrangement in which one end of the second loop antenna element 2 faces a side face of the first loop antenna element 1 in an opposed manner such that they cross each other approximately orthogonally. By selectively setting a gap between one end of the second loop antenna element 2 and the side face of the first loop antenna element 1 within a range of 1.5 to 2.5 mm, as will be described later, it is possible to prevent the deterioration of respective resonance characteristics of the first parallel resonance circuit 11 and the resonance characteristics of the second parallel resonance circuit 12 and, at the same time, it is possible to miniaturize the receiving antenna.

Then, the first differential amplifier 7 has a first input end thereof connected to one end of the first parallel resonance circuit 15, a second input end thereof connected to another end of the first parallel resonance circuit 15, and an output end thereof connected to an input end of the first level detector 10 and a first input end of the signal selector 13. The second differential amplifier 8 has a first input end thereof connected to one end of the second parallel resonance circuit 16, a second input end thereof connected to another end of the second parallel resonance circuit 16, and an output end thereof connected to an input end of the second level detector 11 and a second input end of the signal selector 13. The third differential amplifier 9 has a first input end thereof connected to one end of the third parallel resonance circuit 17, a second input end thereof connected to another end of the third parallel resonance circuit 17, and an output end thereof connected to an input end of the third level detector 12 and a third input end of the signal selector 13. The first level detector 10 has an output end thereof connected to a first control end of the signal selector 13, the second level detector 11 has an output end thereof connected to a second control end of the signal selector 13, and the third level detector 12 has an output end thereof connected to a third control end of the signal selector 13. The signal selector 13 has an output end thereof connected to the signal output terminal 14.

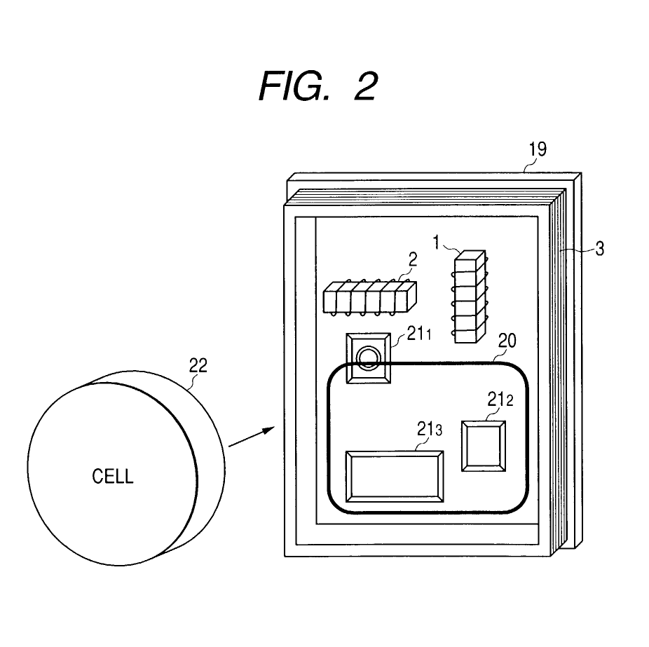

Further, with respect to the receiving antenna of the first embodiment, FIG. 2 is a constitutional view which shows one example in which the first and the second loop antenna elements 1, 2 and the air-core loop antenna element 3 are mounted and arranged on a printed circuit board.

In FIG. 2, numeral 19 indicates a printed circuit board, numeral 20 indicates a high frequency antenna, 21₁, 21₂, 21₃ indicate several types of circuit parts, 22 indicates a cell. Furthermore, constitutional parts which are identical with the constitutional parts shown in FIG. 1 are indicated by the same symbols.

As shown in FIG. 2, the first loop antenna element 1 and the second loop antenna element 2 are arranged in combination such that their axes substantially cross each other orthogonally on one surface of the printed circuit board 19, and one end of the second loop antenna element 2 faces a center region of the side face of the first loop antenna element 1. The air-core loop antenna element 3 is arranged on one surface of the printed circuit board 19 in an erected manner such that the air-core loop antenna element 3 is arranged along the periphery of the printed circuit board 19, and the first and second loop antenna elements 1, 2, the high frequency antenna 20, several types of circuit parts 21₁, 21₂, 21₃, are arranged within the loop, and the cell 22 is mounted in a cell mounting portion of the portable transmitting/receiving apparatus not shown in the drawing when the portable transmitting/receiving apparatus is used.

The receiving antenna having the above-mentioned constitution according to the first embodiment is operated as follows.

Here, when the low-frequency radio signals are transmitted from the vehicle-mounted transmitting/receiving apparatus (not shown in FIG. 1) and transmitted low-frequency radio signals arrive at the receiving antenna of the portable transmitting/receiving apparatus, one or all of the first loop antenna element 1, the second loop antenna element 2 and the air-core loop antenna element 3 detect the low-frequency radio signals. Here, since the first parallel resonance circuit 15 including the first loop antenna element 1, the second parallel resonance circuit 16 including the second loop antenna element 2, and the third parallel resonance circuit 17 including the air-core loop antenna element 3 are respectively constituted such that they are subjected to the parallel resonance to the frequency of the low-frequency radio signals, the received signals having frequencies of respective low-frequency radio signals are formed in one or all of the first parallel resonance circuit 15, the second parallel resonance circuit 16 and the third parallel resonance circuit 17. The received signals formed in the first parallel resonance circuit 15 are subjected to the differential amplification by the first differential amplifier 7 and are converted into the first received signals, and the first received signals are supplied to the first level detector 10 and the signal selector 13 respectively. The received signals formed in the second parallel resonance circuit 16 are subjected to the differential amplification by the second differential amplifier 8 and are converted into the second received signals, and the second received signals are supplied to the second level detector 11 and the signal selector 13 respectively. In the same manner, the received signals formed in the third parallel resonance circuit 17 are subjected to the differential amplification by the third differential amplifier 9 and are converted into the third received signals, and the third received signals are supplied to the third level detector 12 and the signal selector 13 respectively.

The first level detector 10 detects a level of the first received signals supplied from the first differential amplifier 7 and supplies a first detection output corresponding to the first received signal level to the signal selector 13. The second level detector 11 detects a level of the second received signals supplied from the second differential amplifier 8 and supplies a second detection output corresponding to the second received signal level to the signal selector 13. The third level detector 12 detects a level of the third received signals supplied from the third differential amplifier 9 and supplies a third detection output corresponding to the third received signal level to the signal selector 13. The signal selector 13 compares magnitudes of the supplied first detection output, second detection output and third detection output. When the signal selector 13 determines that the first detection output is the largest as a result of sucha comparison, the signal selector 13 selectively outputs the first received signal supplied from the first differential amplifier 7 and supplies the first received signal to the signal output terminal 14. Further, when the signal selector 13 determines that the second detection output is the largest as a result of such a comparison, the signal selector 13 selectively outputs the second received signal supplied from the second differential amplifier 8 and supplies the second received signal to the signal output terminal 14. Further, when the signal selector 13 determines that the third detection output is the largest as a result of such a comparison, the signal selector 13 selectively outputs the third received signal supplied from the third differential amplifier 9 and supplies the third received signal to the signal output terminal 14. Any one of the first received signal, the second received signal and the third received signal supplied to the signal output terminal 14 is supplied to a received signal processor (not shown in FIG. 1) which follows the signal receiver 18.

In the above-mentioned operation of the receiving antenna of the first embodiment, when the receiving signals are formed in the first parallel resonance circuit 15, a magnetic flux which passes an axis of the first loop antenna element 1 is generated in the first loop antenna element 1. In the same manner, when the receiving signals are formed in the second parallel resonance circuit 16, a magnetic flux which passes an axis of the second loop antenna element 2 is generated in the second loop antenna element 2, and when the receiving signals are formed in the third parallel resonance circuit 17, a magnetic flux which passes an axis of the air-core loop antenna element 3 is generated in the air-core loop antenna element 3. In this case, the first loop antenna element 1 and the second loop antenna element 2 are arranged in combination such that the axis of the first loop antenna element 1 and the axis of the second loop antenna element 2 cross each other substantially orthogonally, while the first and second loop antenna elements 1, 2 and the air-core loop antenna element 3 are arranged in combination such that the axes of the first and second loop antenna elements 1, 2 and the axis of the air-core loop antenna element 3 cross each other substantially orthogonally. Accordingly, there is no possibility that the mutual interference of magnetic fluxes is generated between the first and second loop antenna elements 1, 2 as well as between the first and second loop antenna elements 1, 2 andthe air-core loop antenna element 3 where by it is possible to obtain the receiving antenna which can prevent the deterioration of the resonance characteristics of the first parallel resonance circuit 15, the resonance characteristics of the second parallel resonance circuit 16, and the resonance characteristics of the third parallel resonance circuit 17 respectively thus preventing the lowering of the reception sensitivity of the receiving antenna with respect to the low-frequency radio signals.

That is, with respect to the first and second loop antenna elements 1, 2, one end of the second loop antenna element 2 is arranged close to and to face a center region of a side face of the first loop antenna element 1 and hence, the magnetic flux which passes the axis of the first loop antenna element 1 and is radiated into a space from one end and another end of the first loop antenna element 1 is directed in directions away from one end and another end of the second loop antenna element 2. In the same manner, the magnetic flux which passes the axis of the second loop antenna element 2 and is radiated into the space from one end of the second loop antenna element 2 reaches an intermediate portion of the first loop antenna element 1 and then passes through the first loop antenna element 1 by bypassing without passing the axis of the first loop antenna element 1, while the magnetic flux which is radiated into the space from another end of the second loop antenna element 2 is directed in directions away from one end and another end of the first loop antenna element 1. Accordingly, there is no possibility that the mutual interference of the magnetic fluxes is generated between the first and second loop antenna elements 1, 2 so that neither the resonance characteristics of the first parallel resonance circuit 15 nor the resonance characteristics of second parallel resonance circuit 16 are deteriorated.

Further, the first and second loop antenna elements 1, 2 are arranged inside the loop of the air-core loop antenna element 3 and the axis of the air-core loop antenna 3 and the axes of the first and second loop antenna elements 1, 2 are arranged in a state that these axes cross each other orthogonally. Accordingly, the magnetic flux which passes the axis of the air-core loop antenna element 3 and is radiated from one end and another end of the air-core loop antenna element 3 is moved in directions away from one ends and another ends of the first and second loop antenna elements 1, 2 without reaching these ends. Accordingly, there is no possibility that the mutual interference of the magnetic fluxes is generated between the first and second loop antenna elements 1, 2 and the air-core loop antenna element 3 so that the resonance characteristics of the first parallel resonance circuit 15, the resonance characteristics of second parallel resonance circuit 16 and the resonance characteristics of third parallel resonance circuit 17 are not deteriorated.

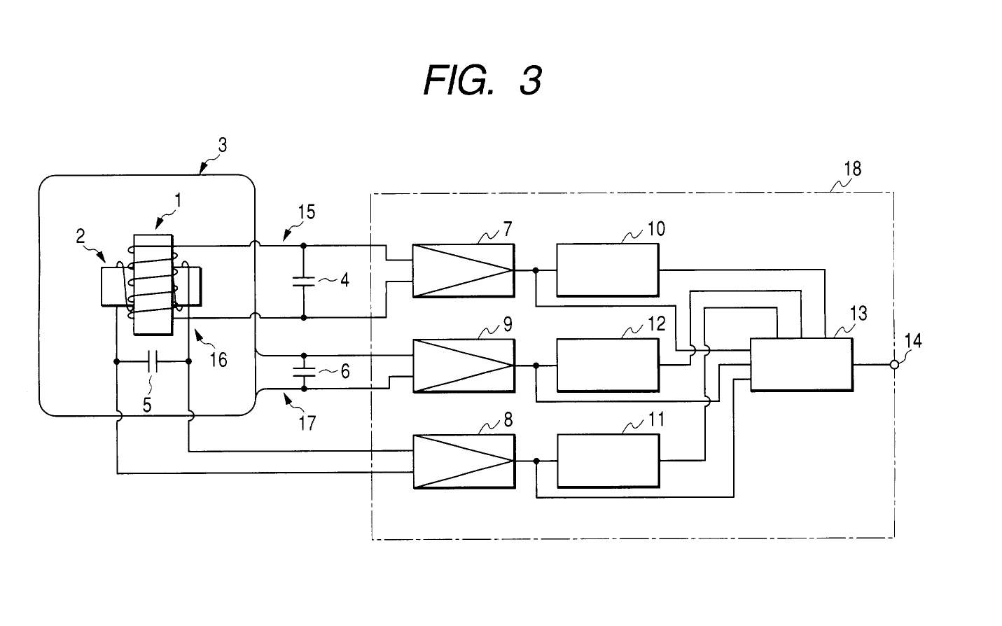

Subsequently, FIG. 3 shows the second embodiment of the method for arranging a receiving antenna according to the present invention and also is a circuit constitutional view showing the constitution of an essential part of the receiving antenna with a part in a block.

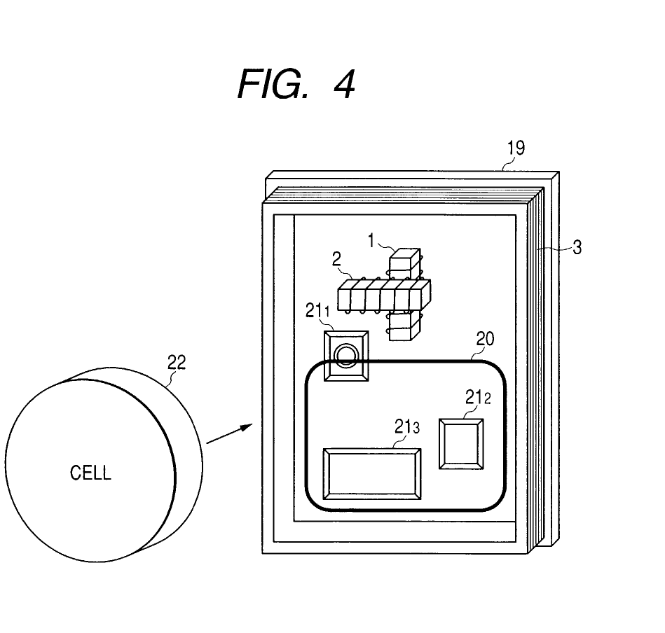

Further, FIG. 4 is a constitutional view showing an example in which first and second loop antenna elements 1, 2 and an air-core loop antenna element 3 are arranged and mounted on a printed circuit board 19 in the receiving antenna of the second embodiment.

In FIG. 3 and FIG. 4, constitutional parts which are identical with the constitutional parts shown in FIG. 1 and FIG. 2 are given same numerals.

As shown in FIG. 3 and FIG. 4, the constitutional difference between a receiving antenna according to the second embodiment (hereinafter referred to as “second embodiment antenna”) and the receiving antenna according to the first embodiment shown in FIG. 1 (hereinafter referred to as “first embodiment antenna”) lies only in the state of arrangement of the first loop antenna element 1 and the second loop antenna element 2 and there is no difference between the first embodiment antenna and the second embodiment antenna with respect to other constitutions.

That is, with respect to the first embodiment antenna, in arranging the first and second loop antenna elements 1, 2 such that these antennas elements 1, 2 cross each other substantially orthogonally, one end of the second loop antenna element 2 is arranged close to and to face the intermediate region of the side face of the first loop antenna element 1. To the contrary, with respect to the second embodiment antenna, in arranging the first and second loop antenna elements 1, 2 such that these antenna elements 1, 2 cross each other substantially orthogonally, the first loop antenna element 1 and the second loop antenna element 2 are arranged to overlap each other in the vertical direction. In this case, it is preferable that the second loop antenna element 2 is arranged on one surface (front surface) side of the printed circuit board 19 and the first loop antenna element 1 is arranged on another surface (rear surface) side of the printed circuit board 19.

In this case, since the constitution of the second embodiment antenna is substantially equal to the constitution of the first embodiment antenna, the manner of operation of receiving the low-frequency radio signals and the manner of processing the received signals in the second embodiment antenna are equal to the manner of operation of receiving the low-frequency radio signals and the manner of processing the received signals in the first embodiment antenna explained heretofore. Accordingly, the manner of operation of receiving the low-frequency radio signals and the manner of processing the received signals in the second embodiment antenna overlap the manner of operation of receiving the low-frequency radio signals and the manner of processing the received signals in the first embodiment antenna explained heretofore and hence, the explanation of the manner of detecting and processing the received signals in the second embodiment antenna is omitted.

In the second embodiment antenna having such a constitution, a magnetic flux which passes the axis of the first loop antenna element 1 and is radiated into a space from one end and another end of the first loop antenna element 1 is directed in directions away from one end and another end of the second loop antenna element 2. On the other hand, amagnetic flux which passes the axis of the second loop antenna element 2 and is radiated into a space from one end and another end of the second loop antenna element 2 is directed in directions away from the one end and another end of the first loop antenna element 1. Accordingly, also with respect to the second embodiment antenna, there is no possibility that the mutual interference of magnetic fluxes is generated between the first and second loop antenna elements 1, 2. Further, there is no possibility that the mutual interference of magnetic fluxes is generated between the first and second loop antenna elements 1, 2 and the air-core loop antenna element 3. Accordingly, the resonance characteristics of the first parallel resonance circuit 15, the resonance characteristics of the second parallel resonance circuit 16 and the resonance characteristics of the third parallel resonance circuit 17 are not deteriorated whereby it is possible to obtain the receiving antenna which can prevent the lowering of the reception sensitivity with respect to the low-frequency radio signals and can enhance the reception sensitivity.

Further, in the second embodiment antenna, when the first and the second loop antenna elements 1, 2 are arranged close to each other, it is possible to confine the arrangement region of these two loop antenna elements 1, 2 in a minimum range so that the optimum miniaturization can be realized.

Here, with respect to the second embodiment antenna, in overlapping the first and second loop antenna elements 1, 2 vertically, as shown in FIG. 4, in place of arranging the first and second loop antenna elements 1, 2 on both surfaces of the printed circuit board 19 such that the first and second loop antenna elements 1, 2 sandwich the printed circuit board 19, the first and second loop antenna elements 1, 2 may be arranged on one surface side of the printed circuit board 19 with a space which defines a minute gap between them.

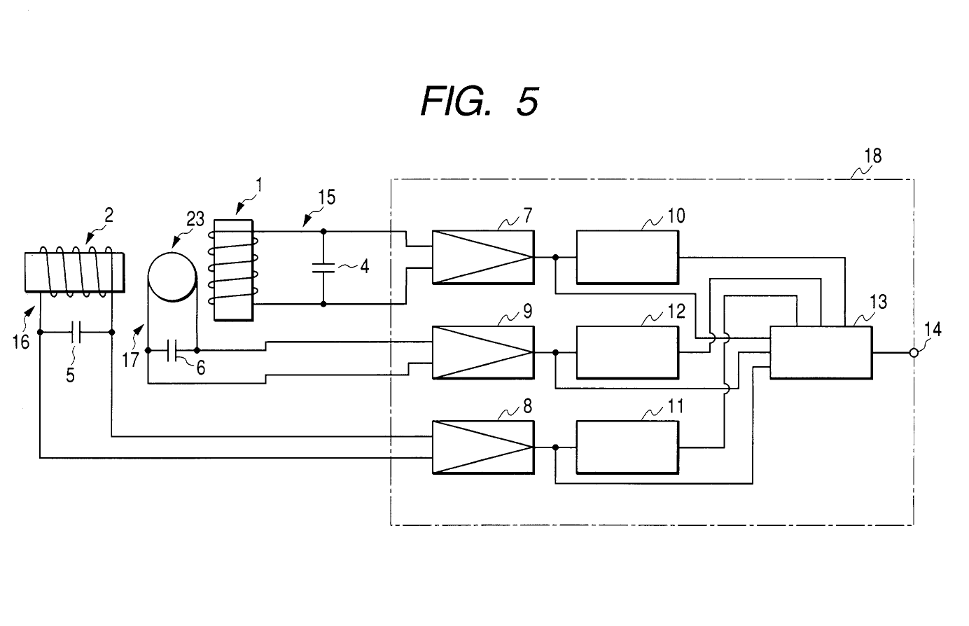

Subsequently, FIG. 5 shows the third embodiment of the method for arranging a receiving antenna according to the present invention and also is a circuit constitutional view showing the constitution of an essential part of the receiving antenna with a part in a block.

In FIG. 5, numeral 23 indicates a third loop antenna element which is formed of a single-core coil-shaped antenna element using a core made of a ferrite material. Constitutional parts which are identical with the constitutional parts shown in FIG. 1 are given same numerals.

As shown in FIG. 5, the constitutional difference between a receiving antenna according to the third embodiment (hereinafter referred to as “third embodiment antenna”) and the first embodiment antenna shown in FIG. 1 merely lies in the selective use between the air-core loop antenna element 3 and the third loop antenna element 23 and there is no difference between the first embodiment antenna and the third embodiment antenna with respect to other constitutions.

That is, in the third embodiment antenna, the first to third loop antenna elements 1, 2, 23 are arranged such that these antenna elements 1, 2, 23 cross each other substantially orthogonally. With respect to the first and second loop antenna elements 1, 2, one end of the second loop antenna element 2 is arranged close to and to face the center region of the side face of the first loop antenna element 1. With respect to the first and third loop antenna elements 1, 23, the side face of the first loop antenna element 1 and the side face of the third loop antenna element 23 are arranged close to each other in a state that these side faces cross each other orthogonally. With respect to the second and third loop antenna elements 2, 23, one end of the second loop antenna element 2 is arranged close to and to face the center region of the side face of the third loop antenna element 23.

Also in this case, since the constitution of the third embodiment antenna is substantially equal to the constitution of the first embodiment antenna, the manner of operation of receiving the low-frequency radio signals and the manner of processing the received signals in the third embodiment antenna are equal to the manner of operation of receiving the low-frequency radio signals and the manner of processing the received signals in the first embodiment antenna explained heretofore. Accordingly, the manner of operation of receiving the low-frequency radio signals and the manner of processing the received signals in the third embodiment antenna overlap the manner of operation of receiving the low-frequency radio signals and the manner of processing the received signals in the first embodiment antenna described above and hence, the explanation of the manner of detecting and processing the received signals in the third embodiment antenna is omitted.

In the third embodiment antenna having such a constitution, since the first to third loop antenna elements 1, 2, 23 are arranged in the above-mentioned manner, a magnetic flux which is radiated from one end and another end of each one of the first to third loop antenna elements 1, 2, 23 is directed in directions away from one ends and another ends of other remaining loop antenna elements. Therefore, also with respect to the third embodiment antenna, there is no possibility that the mutual interference of magnetic fluxes is generated between the first, second and third loop antenna elements 1, 2, 23. Accordingly, the resonance characteristics of the first parallel resonance circuit 15, the resonance characteristics of the second parallel resonance circuit 16 and the resonance characteristics of the third parallel resonance circuit 17 are not deteriorated whereby it is possible to obtain the receiving antenna which can prevent the lowering of the reception sensitivity with respect to the low-frequency radio signals and can enhance the reception sensitivity.

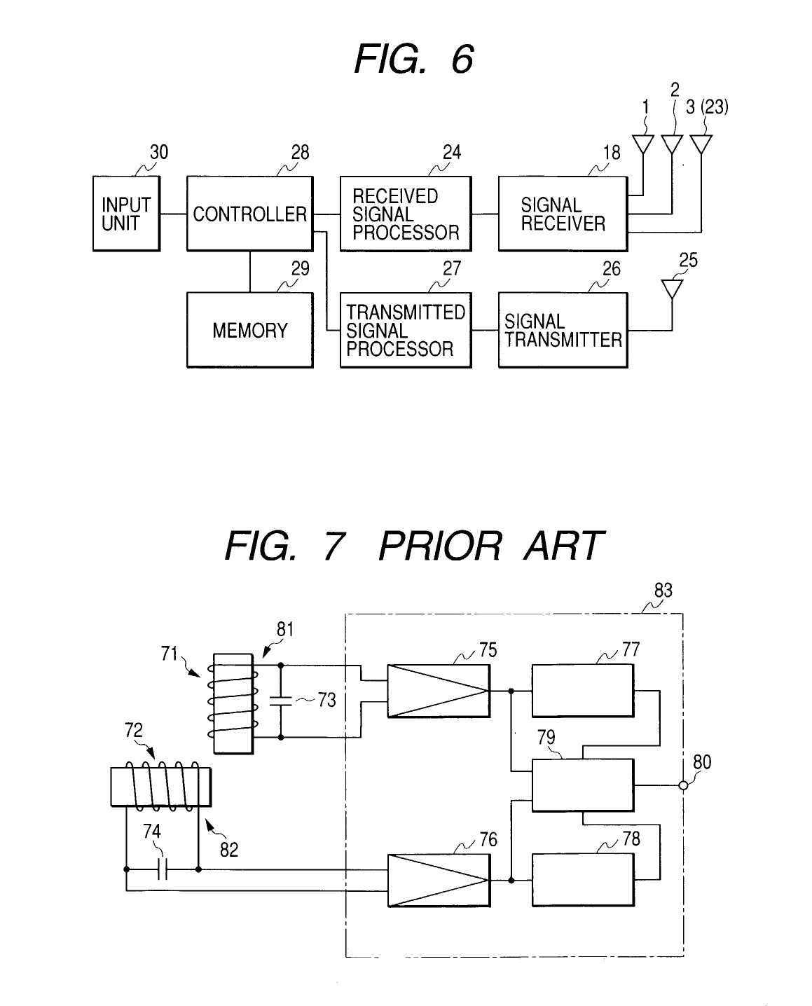

Subsequently, FIG. 6 is a block diagram showing one example of the constitution of an essential part of a portable transmitting/receiving apparatus provided with any one of the receiving antennas of the first to third embodiments.

As shown in FIG. 6, the portable transmitting/receiving apparatus includes a signal receiver 18 which has three antenna elements 1, 2, 3 (23), a received signal processor 24, a signal transmitter 26 which has one high-frequency antenna 25, a transmitted signal processor 27, a controller 28, a memory 29 and an input unit 30.

Here, the received signal processor 24 is configured to be operated such that the part 24 processes the received signal obtained by reception of the low-frequency radio signals and supplies a result of processing to the controller 28 as received data. The signal transmitter 26 is configured to be operated such that the part 26 forms high-frequency radio signals which are transmitted to a vehicle-mounted transmitting/receiving apparatus (not shown in FIG. 6) through a high frequency antenna 25. The transmitted signal processor 27 is configured to be operated such that the part 27 processes the transmitted data supplied from the controller 28 and forms signals suitable for transmission. The controller 28 is configured to be operated such that the controller 28 systematically controls the operation of respective parts. The memory 29 is a part which stores necessary data and a result of computation based on the control of the controller 28. The input unit 30 generates manipulation signals based on the manipulation of respective manipulation parts and supplies the manipulation signals to the controller 28.

Here, since both of the constitution and the manner of operation of the portable transmitting/receiving apparatus are well known in the technical field to which the apparatus pertains, no further explanation is made with respect to the constitution and the manner of operation of the portable transmitting/receiving apparatus.

To recapitulate the present invention, according to the first aspect of the present invention, with respect to two loop antenna elements, they are arranged in combination such that the magnetic flux which passes the axis of one loop antenna element is prevented from passing the axis of another loop antenna element, while with respect to one air-core loop antenna element, such a loop antenna element is arranged in combination such that the magnetic flux which passes the axis of the air-core loop antenna passes neither the axis of one loop antenna element nor the axis of another loop antenna element. Due to such a constitution, the generation of the mutual interference of magnetic fluxes between one and another loop antenna elements and the generation of the mutual interference of magnetic fluxes between one air-core loop antenna element and the one and other loop antenna elements can be eliminated. Accordingly, it is possible to maintain in a favorable state the resonance characteristics of the first parallel resonance circuit which is constituted of one loop antenna element and the resonance capacitor which is connected to one loop antenna element in parallel, the resonance characteristics of the second parallel resonance circuit which is constituted of another loop antenna element and the resonance capacitor which is connected to another loop antenna element in parallel, and the resonance characteristics of the third parallel resonance circuit which is constituted of the air-core loop antenna element and the resonance capacitor which is connected to the air-core loop antenna element in parallel. Accordingly, even when two loop antenna elements and one air-core loop antenna element are arranged close to each other to miniaturize the receiving antenna, the reception sensitivity can be enhanced without lowering the reception sensitivity with respect to low-frequency radio signals.

According to the second aspect of the present invention, it is possible to surely suppress the generation of the mutual interference of the magnetic flux between one and another loop antenna elements. Accordingly, even when one and another loop antenna elements are arranged close to eachother and the air-core loop antenna element is arranged close to one and another loop antenna elements, there arises no lowering of the reception sensitivity with respect to the low-frequency radio signals so that the reception sensitivity can be enhanced.

According to the third aspect of the present invention, it is possible to surely suppress the generation of the mutual interference of the magnetic fluxes between one and another loop antenna elements. Further, it is possible to confine the arrangement region of loop antenna elements when one and another loop antenna elements are arranged close to each other to the minimum range so that the optimum miniaturization can be realized. Still further, even when the air-core loop antenna element is arranged close to one and another loop antenna elements, there arises no lowering of the reception sensitivity with respect to the low-frequency radio signals so that the reception sensitivity can be enhanced.

Further, according to fourth aspect of the present invention, three loop antenna elements are arranged in combination such that the axis of each one loop antenna element crosses respective axes of other two loop antenna elements orthogonally and the magnetic flux which passes the axis of each one loop antenna element is prevented from passing respective axes of the other two loop antenna elements. Accordingly, it is possible to eliminate the generation of the mutual interference of magnetic fluxes between respective two of three loop antenna elements so that it is possible to maintain in a favorable state the resonance characteristics of respective parallel resonance circuits each of which is constituted of each loop antenna element and the resonance capacitor which is connected to the loop antenna element inparallel. Accordingly, even when three loop antenna elements are arranged close to each other for miniaturizing the receiving antenna, it is possible to prevent the lowering of the reception sensitivity with respect to the low-frequency radio signals so that the reception sensitivity can be enhanced.

What is claimed is:

1. A method for arranging a receiving antenna comprising:
arranging two loop antenna elements and one air-core loop antenna element that form the receiving antenna close to each other;
arranging the two loop antenna elements such that a magnetic flux which passes an axis of each loop antenna element does not pass through an axis of the other loop antenna element; and
arranging the air-core loop antenna element such that an axis of the air-core loop antenna crosses respective axes of the two loop antenna elements orthogonally.

2. A method for arranging a receiving antenna according to claim 1, further comprising arranging the two loop antenna elements such that the two loop antenna elements cross each other substantially orthogonally, an end of a first loop antenna element of the two loop antenna elements faces a side face of a second loop antenna element of the two loop antenna elements.

3. A method for arranging a receiving antenna according to claim 1, further comprising arranging the two loop antenna elements and the one air-core loop antenna element on one surface of a printed circuit board.

4. A method for arranging a receiving antenna according to claim 3, further comprising arranging the two loop antenna elements inside a loop of the one air-core loop antenna element.

5. A method for arranging a receiving antenna according to claim 1, further comprising arranging the two loop antenna elements such that the two loop antenna elements cross each other substantially orthogonally and overlap each other.

6. A method for arranging a receiving antenna according to claim 5, wherein with respect to the two loop antenna elements, a first loop antenna element is arranged on one surface of a printed circuit board and a second loop antenna element is arranged on another surface of the printed circuit board.

7. A method for arranging a receiving antenna according to claim 6, wherein with respect to the two loop antenna elements, the first loop antenna element is arranged inside a loop of the one air-core loop antenna element.

8. A method for arranging a receiving antenna comprising:
arranging three loop antenna elements that form the receiving antenna close to each other;
arranging the three loop antenna elements such that an axis of each loop antenna element crosses respective axes of the other two loop antenna elements orthogonally; and
preventing a magnetic flux which passes each loop antenna element from passing respective axes of the other two loop antenna elements.

9. A method for arranging a receiving antenna according to claim 2, further comprising arranging the two loop antenna elements and the one air-core loop antenna element on one surface of a printed circuit board.

10. A method for arranging a receiving antenna according to claim 9, further comprising arranging the two loop antenna elements inside a loop of the one air-core loop antenna element.

11. A receiving antenna comprising:
two loop antenna elements disposed close to each other and arranged such that a magnetic flux which passes an axis of each loop antenna element does not pass through an axis of the other loop antenna element; and
one air-core loop antenna element disposed close to the two loop antenna elements and arranged such that an axis of the air-core loop antenna crosses respective axes of the two loop antenna elements orthogonally.

12. A receiving antenna according to claim 11, wherein the two loop antenna elements cross each other substantially orthogonally and an end of a first loop antenna element of the two loop antenna elements faces a side face of a second loop antenna element of the two loop antenna elements.

13. A receiving antenna according to claim 11, wherein the two loop antenna elements and the one air-core loop antenna element are disposed on one surface of a printed circuit board.

14. A receiving antenna according to claim 13, wherein the two loop antenna elements are disposed inside a loop of the one air-core loop antenna element.

15. A receiving antenna according to claim 12, wherein the two loop antenna elements and the one air-core loop antenna element are disposed on one surface of a printed circuit board.

16. A receiving antenna according to claim 15, wherein the two loop antenna elements are disposed inside a loop of the one air-core loop antenna element.

17. A receiving antenna according to claim 11, wherein the two loop antenna elements cross each other substantially orthogonally and overlap each other.

18. A receiving antenna according to claim 17, wherein with respect to the two loop antenna elements, a first loop antenna element is arranged on one surface of a printed circuit board and a second loop antenna element is arranged on another surface of the printed circuit board.

19. A receiving antenna according to claim 18, wherein with respect to the two loop antenna elements, the first loop antenna element is arranged inside a loop of the one air-core loop antenna element.

20. A receiving antenna comprising three loop antenna elements disposed close to each other, the three loop antenna elements disposed such that an axis of each loop antenna element crosses respective axes of the other two loop antenna elements orthogonally and a magnetic flux which passes each loop antenna element is prevented from passing respective axes of the other two loop antenna elements.
